(19) United States
(12) Patent Application Publication
(10) Pub. No.: US 2016/0182163 A1
(43) Pub. Date: Jun. 23, 2016

(54) METHOD FOR DETERMINING AN OPTIMUM SET OF TRANSMITTING/RECEIVING BEAMS AND A COMMUNICATIONS DEVICE UTILIZING THE SAME

(71) Applicant: MediaTek Inc., Hsin-Chu (TW)

(72) Inventors: Jiann-Ching GUEY, Hsinchu City (TW); Yu-Chuan LIN, New Taipei City (TW); Tsung-Yu CHIOU, Zhudong Township (TW)

(21) Appl. No.: 14/623,820

(22) Filed: Feb. 17, 2015

Related U.S. Application Data
(60) Provisional application No. 62/093,568, filed on Dec. 18, 2014.

(51) Int. Cl. H04B 17/12; H04B 17/391; H04B 17/27; H04B 7/04

(52) U.S. Cl. CPC H04B 17/12; H04B 7/0408; H04B 17/3913; H04B 17/27

(57) ABSTRACT

A communications device is provided. The transceiver module transmits and receives signals via one or more transmitting beams and one or more receiving beams. The communications state measurement module measures strength of the received signals to obtain a spatial profile including information regarding received signal strength for the one or more receiving beams with respect to one or more transmitting beams of another communications device communicating with the communications device. The sensor module senses a status of the communications device to obtain context information of the communications device according to the sensed status. The communications control module obtains the spatial profile from the communications state measurement module and the context information from the sensor module and determining an optimum action to control the transceiver module to search, track and/or adjust the one or more receiving beams according to the spatial profile and the context information.

### CROSS REFERENCE TO RELATED APPLICATIONS

This application claims the benefit of U.S. Provisional Application No. 62/093,568, filed 2014 Dec. 18, and entitled “Robust Mobile Communication with In-Device Sensors Assistance”, and the entire contents of which are hereby incorporated by reference.

### BACKGROUND OF THE INVENTION

1. Field of the Invention

The invention relates to a communications device and methods for determining an optimum set of transmitting/receiving beams for a communications device to speed up the beam-search and beam-track procedure of the communications device.

2. Description of the Related Art

Multipath propagation can be a relevant error source in wireless communications, particularly in areas with a high fraction of signal reflections such as in urban areas with large buildings. Due to multipath propagation, receivers receive reflected signals from transmitters, which can cause multipath interference with direct signals. Such multipath interference limits the speed and accuracy of the wireless communications.

In order to overcome the problem of multipath interference problem, beamforming technology has been proposed. The transmitter of a first device transmits a known pilot signal in various directions via multiple transmitting beams. The receiver of a second device scans the pilot signal transmitted by the first device via the transmitting beams via all possible receiving beams to find an optimum receiving beam and a corresponding optimal transmitter beam of the first device for the following reception. The second device may communicate such finding to the first device via certain feedback channel.

However, it is very time consuming and the system overhead is high when searching for the optimum transmitting/receiving beam, especially when a communications device was just powered on. In addition, the optimum transmitting/receiving beam usually changes when the communications device moves. In the case of beamforming at very high carrier frequency, the optimum transmitting/receiving beam is more sensitive to the location, orientation and movement of the communications device. Therefore, how to speed up the beam-search and beam-track procedure is an issue worthy of concern.

### BRIEF SUMMARY OF THE INVENTION

Communications devices and methods for determining an optimum set of transmitting/receiving beams for a communications device are provided. An exemplary embodiment of a communications device comprises a transceiver module, a communications state measurement module, a sensor module and a communications control module. The transceiver module transmits and receives a plurality of signals to and from an air interface via one or more transmitting beams and one or more receiving beams. The communications state measurement module measures strength of the received signals to obtain a spatial profile comprising information regarding received signal strength for the one or more receiving beams with respect to one or more transmit beams of another communications device communicating with communications first device. The sensor module senses a status of the communications device to obtain context information of the communications device according to the sensed status. The communications control module obtains the spatial profile from the communications state measurement module and the context information from the sensor module and determines an optimum action to control the transceiver module to search, track and/or adjust the one or more transmitting beams according to the spatial profile and the context information.

Another exemplary embodiment of a communications device comprises a transceiver module, a communications state measurement module, a sensor module and a communications control module. The transceiver module transmits and receives a plurality of signals to and from an air interface via one or more transmitting beams and one or more receiving beams. The communications state measurement module measures strength of the received signals to obtain a spatial profile comprising information regarding received signal strength for the one or more receiving beams with respect to one or more transmitting beams of another communications device communicating with the communications device. The sensor module senses a status of the communications device to obtain context information of the communications device according to the sensed status. The communications control module obtains the spatial profile from the communications state measurement module and the context information from the sensor module and determines an optimum action to control the transceiver module to search, track and/or adjust the one or more receiving beams according to the spatial profile and the context information.

An exemplary embodiment of a method for determining an optimum set of transmitting/receiving beams for a first communications device comprises: measuring strength of a plurality of signals received via one or more receiving beams of the first communications device to obtain a spatial profile comprising information regarding the received signal strength for the one or more receiving beams of the first communications device with respect to one or more transmitting beams of a second communications device communicating with the first communications device; sensing a status of the communications device to obtain context information of the communications device according to the sensed status; and determining an optimum action to control a transceiver module of the communications device to search, track and/or adjust the one or more receiving beams or one or more transmitting beams according to the spatial profile and the context information.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 is a block diagram of a communications device according to an embodiment of the invention;

FIG. 2 is a block diagram of a communications device according to another embodiment of the invention;

FIG. 3 is a schematic diagram showing a plurality of transmitting beams generated by a transmitter communications device and a plurality of receiving beams generated by a receiver communications device;

FIG. 4 is a flow chart of a method for determining an optimum set of transmitting/receiving beams for a communications device according to an embodiment of the invention;

FIG. 5 shows an exemplary spatial profile represented by a 3-dimensional statistical chart according to an embodiment of the invention;

FIG. 6 shows an exemplary block diagram of a communications control module according to an embodiment of the invention; and

FIG. 7 is a flow chart of a method to speed up the beam-search or beam-track procedure according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

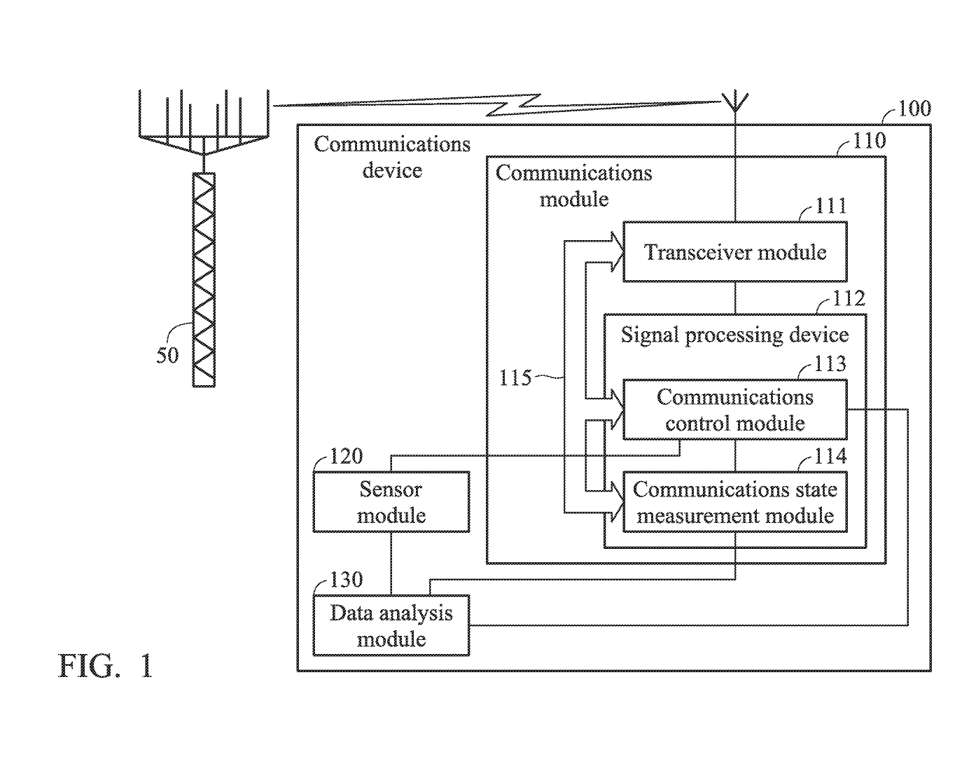

FIG. 1 is a block diagram of a communications device according to an embodiment of the invention. According to an embodiment of the invention, the communications device 100 is capable of communicating with another communications device 50 (such as a base station as shown) in a service network, and may comprise at least an antenna module comprising one or more antennas, a communications module 110, a sensor module 120 and a data analysis module 130. The communications module 110 provides wireless communications functionality. The sensor module 120 may comprise one or more sensors each for sensing a current status of the communications device 100, such as movement of the communications device 100, and obtain context information of the communications device 100 according to the sensed status. The data analysis module 130 may analyze a plurality of training data points obtained at different time to generate a data analysis result.

In some embodiments of the invention, the communications device 100 may also comprise a controller or a processor (not shown) for controlling the operation of the communications module 110, the sensor module 120, the data analysis module 130, and other functional components (not shown) such as a display unit and/or keypad serving as the MMI (man-machine interface), a storage unit storing data and program codes of applications or communications protocols, and other functional components.

According to an embodiment of the invention, the communications module 110 may comprise at least a transceiver module 111 and a signal processing device 112. The transceiver module 111 is coupled to the antenna module and transmits a plurality of signals to and receives a plurality of signals from an air interface via one or more transmitting beams and one or more receiving beams generated by the antenna module. According to an embodiment of the invention, the transceiver module 111 may control the antenna module to generate the transmitting beams and receiving beams directed in different directions. In addition, in some embodiments of the invention, the transceiver module 111 may further act as a front-end signal processing device to process (for example, amplifying and filtering) the signals to be transmitted to and received from the air interface.

The signal processing device 112 may further process the signals to be transmitted to and received from the transceiver module 111, where the signal processing may comprise baseband signal processing and/or Radio Frequency (RF) signal processing. According to an embodiment of the invention, the signal processing device 112 may comprise a plurality of hardware devices (not shown), firmware modules and/or software modules to perform baseband signal processing, such as Analog to Digital Conversion (ADC)/Digital to Analog Conversion (DAC), gain adjusting, modulation/demodulation, encoding/decoding, and so on. The signal processing device 112 may also comprise a plurality hardware devices (not shown) to perform radio frequency conversion and RF signal processing, such as frequency down-conversion and up-conversion, amplification, filtering and so on.

Note that in order to clarify the concept of the invention, FIG. 1 presents a simplified block diagram, in which only the elements relevant to the invention are shown. Therefore, the invention should not be limited to what is shown in FIG. 1. Note further that as well known in the art, there are plenty of ways to design the hardware devices, firmware modules and/or software modules comprised in the transceiver module 111, the signal processing device 112 and the communications module 110. Therefore, the designs of the transceiver module 111, the signal processing device 112, and the communications module 110 of the proposed communications apparatus 100 should not be limited to any specific method of implementation.

According to an embodiment of the invention, the signal processing device 112 may comprise a communications control module 113 and a communications state measurement module 114. The communications state measurement module 114 may measure strength of the received signals to obtain a spatial profile comprising information regarding received signal strength for at least the one or more receiving beams with respect to the one or more transmitting beams of another communications device communicating with the communications device 100. The communications control module 113 may obtain the spatial profile from the communications state measurement module 114 and the context information from the sensor module 120 and determine an optimum action to control the transceiver module 111 to search, track and/or adjust the one or more transmitting beams and/or the one or more receiving beams according to the spatial profile and the context information. In some embodiments of the invention, the communications control module 113 may also determine the optimum action further according to the data analysis result obtained from the data analysis module 130. The communications control module 113, the communications state measurement module 114 and the transceiver module 111 may communicate with each other via the internal bus 115 coupled thereto. Note that in yet some embodiments of the invention, the communications control module 113 may not only determine the optimum action of the communications device 100, but also determine the optimum action of another communications device that is communicating with the communications device 100. For example, the communications control module 113 may determine a suggested angle for tuning the transmitting/receiving beam and provide information regarding the suggested angle to the other communications device via a higher layer signaling, so as to help to speed up the beam-search or beam-track procedure of the other communications device as well.

Note that in some embodiments of the invention, instead of being configured inside of the communications device, the data analysis module may also be configured in a cloud server, and the communications control module may communicate with the cloud server to obtain the data analysis result.

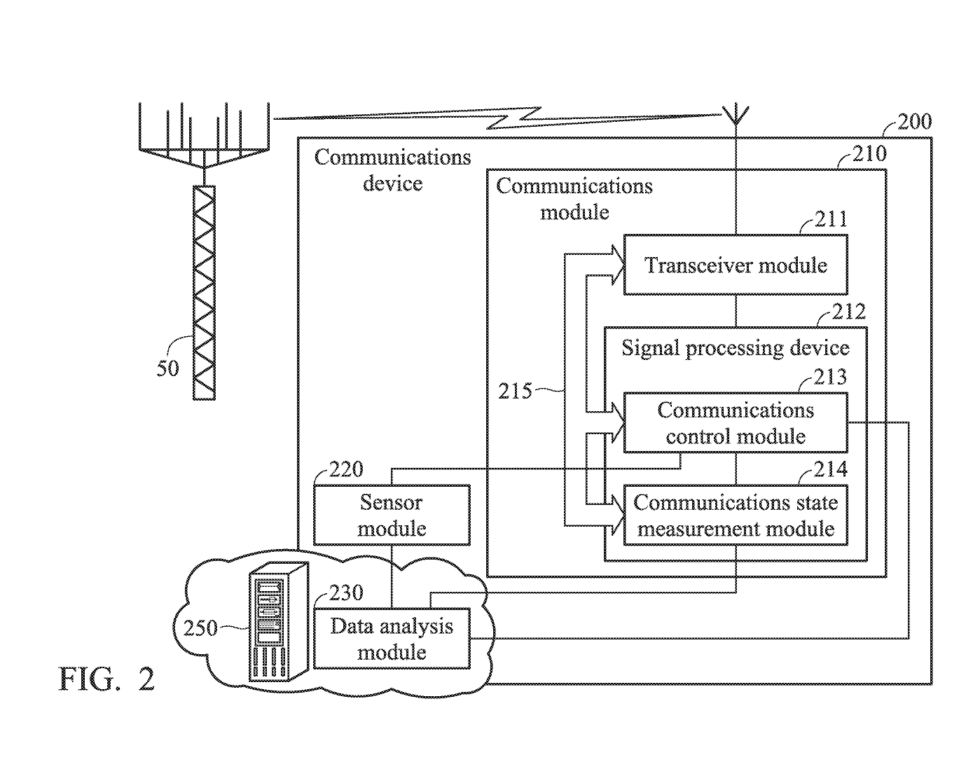

FIG. 2 is a block diagram of a communications device according to another embodiment of the invention. According to an embodiment of the invention, the communications device 200 is capable of communicating with another communications device 50 (such as a base station as shown) in a service network, and may comprise at least an antenna module comprising one or more antennas, a communications module 210 and a sensor module 220. The communications module 210 provides wireless communications functionality. The sensor module 220 may comprise one or more sensors each for sensing a current status of the communications device 200, such as movement of the communications device 200, and obtain context information of the communications device 200 according to the sensed status. In the embodiment, the data analysis module 230 may be configured in a cloud server 250 and may analyze a plurality of training data points obtained at different time to generate a data analysis result.

In some embodiment of the invention, the communications device 200 may also comprise a controller or a processor (not shown) for controlling the operation of the communications module 210, the sensor module 220 and other functional components (not shown) such as a display unit and/or keypad serving as the MMI (man-machine interface), a storage unit storing data and program codes of applications or communications protocols, and other functional components.

According to an embodiment of the invention, the communications module 210 may comprise at least a transceiver module 211 and a signal processing device 212. The transceiver module 211 is coupled to the antenna module and transmits a plurality of signals to and receives a plurality of signals from an air interface via one or more transmitting beams and one or more receiving beams generated by the antenna module. According to an embodiment of the invention, the transceiver module 211 may control the antenna module to generate the transmitting beams and receiving beams directing to different directions. In addition, in some embodiments of the invention, the transceiver module 211 may further act as a front-end signal processing device to process (for example, amplifying and filtering) the signals to be transmitted to and received from the air interface.

The signal processing device 212 may further process the signals to be transmitted to and received from the transceiver module 211, where the signal processing may comprise baseband signal processing and/or Radio Frequency (RF) signal processing. According to an embodiment of the invention, the signal processing device 212 may comprise a plurality hardware devices (not shown), firmware modules and/or software modules to perform baseband signal processing, such as Analog to Digital Conversion (ADC)/Digital to Analog Conversion (DAC), gain adjusting, modulation/demodulation, encoding/decoding, and so on. The signal processing device 212 may also comprise a plurality hardware devices (not shown) to perform radio frequency conversion and RF signal processing, such as frequency down conversion and up conversion, amplifying, filtering and so on.

Note that in order to clarify the concept of the invention, FIG. 2 presents a simplified block diagram, in which only the elements relevant to the invention are shown. Therefore, the invention should not be limited to what is shown on the FIG. 2. Note further that, as is well known in the art, there are plenty of ways to design the hardware devices, firmware modules and/or software modules comprised in the transceiver module 211, the signal processing device 212 and the communications module 210. Therefore, the designs of the transceiver module 211, the signal processing device 212 and the communications module 210 of the proposed communications apparatus 200 should not be limited to any specific way of implementation.

According to an embodiment of the invention, the signal processing device 212 may comprise a communications control module 213 and a communications state measurement module 214. The communications state measurement module 214 may measure strength of the received signals to obtain a spatial profile comprising information regarding received signal strength for at least the one or more receiving beams with respect to one or more transmitting beams of another communications device communicating with the communications device 200. The communications control module 213 may obtain the spatial profile from the communications state measurement module 214 and the context information from the sensor module 220 and determine an optimum action to control the transceiver module 211 to search, track and/or adjust the one or more transmitting beams and/or the one or more receiving beams according to the spatial profile and the context information. In some embodiments of the invention, the communications control module 213 may also determine the optimum action further according to the data analysis result obtained from the data analysis module 230. The communications control module 213 may communicate with the data analysis module 230 in the cloud server 250 to obtain the data analysis result. The communications control module 213, the communications state measurement module 214 and the transceiver module 211 may communicate with each other via the internal bus 215 coupled thereto. Note that in yet some embodiments of the invention, the communications control module 213 may not only determine the optimum action of the communications device 200, but also determine the optimum action of another communications device that is communicating with the communications device 200. For example, the communications control module 213 may determine a suggested angle for tuning the transmitting/receiving beam and provide information regarding the suggested angle to the other communications device via a higher layer signaling, so as to help to speed up the beam-search or beam-track procedure of the other communications device as well.

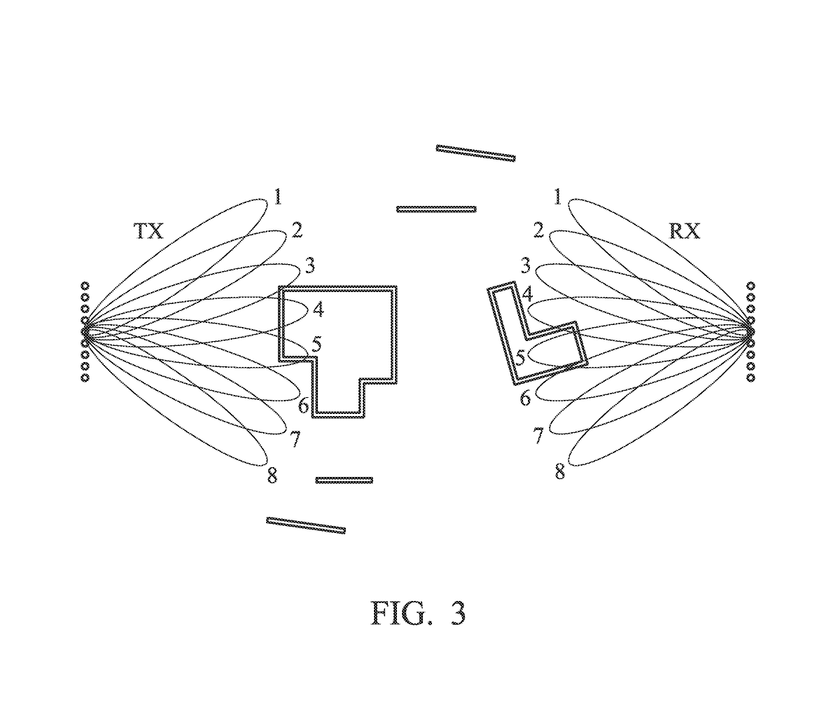

FIG. 3 is a schematic diagram showing a plurality of transmitting beams generated by a transmitter communications device (TX) and a plurality of receiving beams generated by a receiver communications device (RX). In the exemplary scenario shown in FIG. 3, there are 8 transmitting beams generated by the transmitter communications device and 8 receiving beams generated by the receiver communications device. In addition, there are many obstructions distributed between the transmitter communications device and the receiver communications device. In order to find out at least one optimum transmitting beam and at least one optimum receiving beam for wireless communications, it takes 64 (that is, 8*8) combinations for each round in a beam-search procedure for searching the optimum transmitting beam and the optimum receiving beam among the 8 transmitting beams and 8 receiving beams. It is very time consuming and the overhead is high, especially when the number of possible transmitting beams and the number of possible receiving beams supported by the transmitter communications device and the receiver communications device increase.

In order to speed up the beam-search and beam-track procedure, methods for determining an optimum set of transmitting/receiving beams and the communications device (e.g. the communications device 100 or 200 as shown) utilizing the same will be discussed further in the following paragraphs.

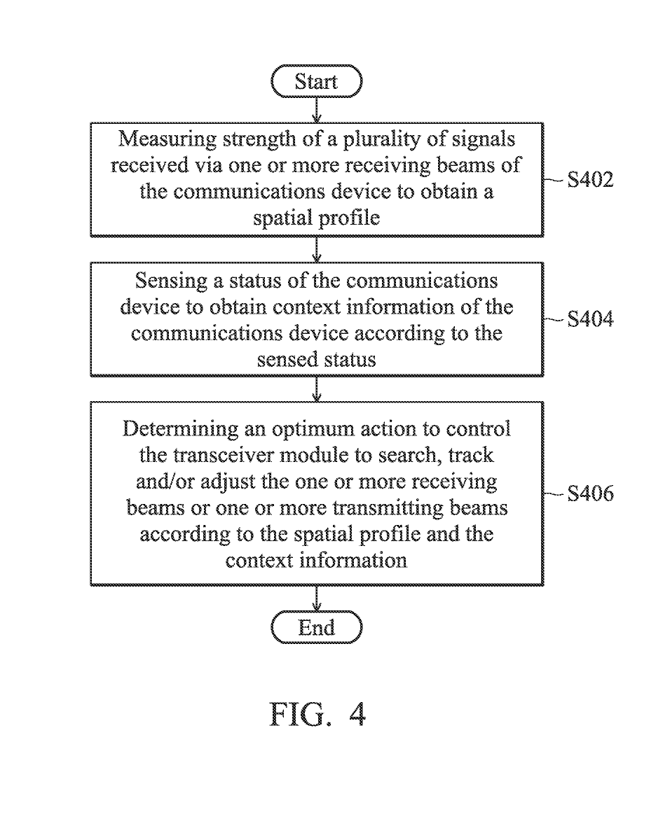

FIG. 4 is a flow chart of a method for determining an optimum set of transmitting/receiving beams for a communications device according to an embodiment of the invention. The communications state measurement module (e.g. the communications state measurement module 114/214) may measure strength of a plurality of signals received via one or more receiving beams of the communications device (e.g. the communications device 100/200) to obtain a spatial profile comprising information regarding the received signal strength for the one or more receiving beams (Step S402) with respect to the one or more transmit beams of another communications device communicating with the communications device. The received signal strength with respect to a specific receiving beam (and a specific transmitting beam) refers to the signal strength received when the signal received by the receiver communications device is turned in a specific beam direction (and the signal transmitted by the transmitter communications device is turned to a specific beam direction). According to an embodiment of the invention, the spatial profile may be represented in a list or a table of data, or a 2-dimensional or a 3-dimensional statistical chart.

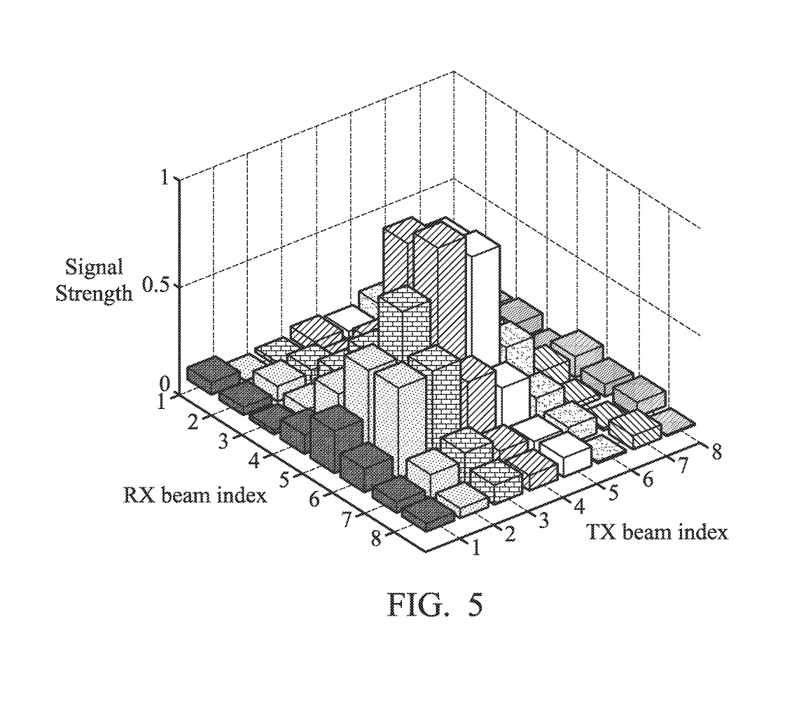

FIG. 5 shows an exemplary spatial profile represented by a 3-dimensional statistical chart according to an embodiment of the invention. In this embodiment, the spatial profile comprises information regarding the received signal strength with respect to the receiving beams of the receiver communications device and the transmitting beams of the transmitter communications device. Therefore, one axis of the spatial profile records the receiving beam index RX beam index of the receiver communications device, one axis of the spatial profile records the transmitting beam index TX beam index of the transmitter communications device, and one axis of the spatial profile records the signal strength. Note that in some embodiments of the invention, information regarding the beam pattern for each transmitting beam and/or receiving beam may also be recorded. Note further that in some embodiments of the invention, the spatial profile may also be represented by a list or a table of data, or a 2-dimensional statistical chart comprising information regarding the received signal strength with respect to the receiving beam index RX beam index. Therefore, the invention should not be limited to the example shown in FIG. 5.

Referring back to FIG. 4, besides the spatial profile, the sensor module (e.g. the sensor module 120/220) may sense a status of the communications device to obtain context information of the communications device according to the sensed status (Step S404). According to an embodiment of the invention, the status of the communications device may comprise at least one of a location, a 3D orientation, a proximity to a path-blocking object and a moving speed of the communications device, or others. Here, the location may be represented by an absolute location or a relative location. The sensor module may comprise at least one of a Global Positioning System (GPS) receiver, a gyroscope sensor, a proximity sensor and a gravity sensor to sense the status of the communications device.

Next, the communications control module (e.g. the communications control module 113/213) may determine an optimum action to control a transceiver module of the communications device to search, track and/or adjust the one or more receiving beams or one or more transmitting beams according to the spatial profile and the context information (Step S406). Note that in some embodiments of the invention, the communications control module may also determine the optimum action further according to the data analysis result obtained from the data analysis module (e.g. the data analysis module 130/230). The ways to determine the optimum action to control the transceiver module are further discussed in the following paragraphs.

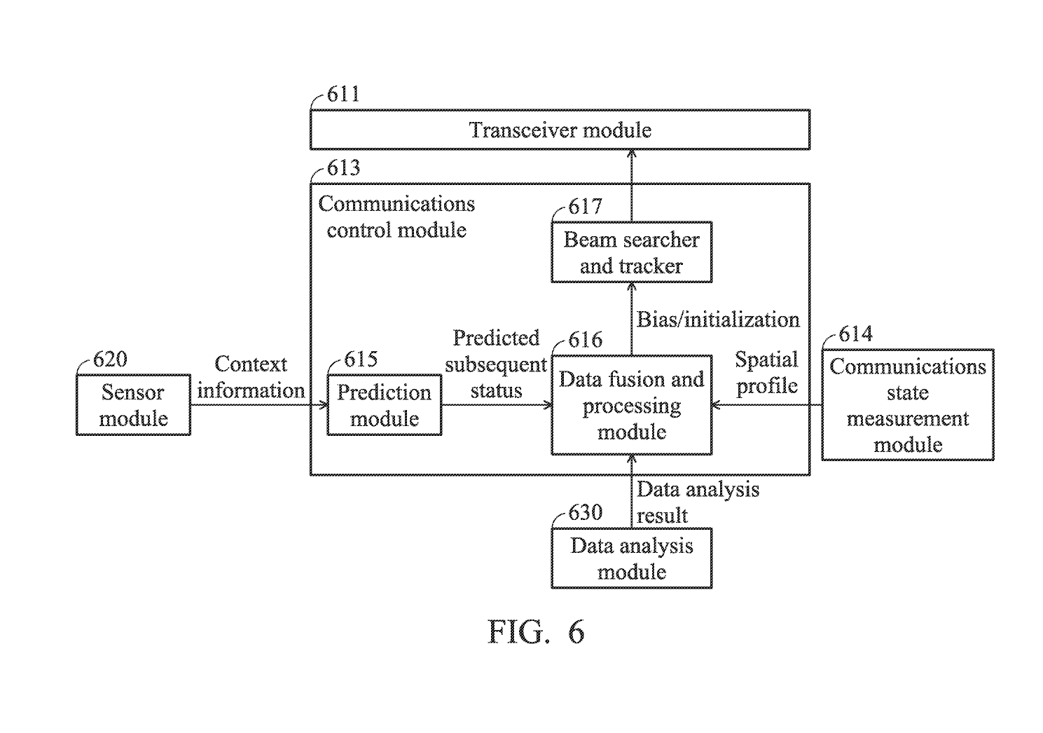

FIG. 6 shows an exemplary block diagram of a communications control module according to an embodiment of the invention. According to an embodiment of the invention, the communications control module 613 may comprise a prediction module 615, a data fusion and processing module 616 and a beam searcher and tracker 617. The prediction module 616 may receive the context information from the sensor module 620 and predict a subsequent status of the communications device according to the currently received context information and previously received context information (if there is). For example, the prediction module 616 may predict a subsequent location, 3D orientation, a proximity to a path-blocking object or moving speed of the communications device according to the currently received context information and previously received context information.

The data analysis module 630 may obtain the context information and the spatial profile, synchronize the spatial profile with the context information obtained at the same time to form a training data point at a predetermined time, and analyze a plurality of training data points obtained at different time to generate the data analysis result. The training data points obtained at different time may be recorded by the data analysis module 630 as a database. In addition, according to some embodiments of the invention, the data analysis module 630 may further process data associated with the training data points by filtering, averaging, interpolating and/or extrapolating the data, so as to reduce noise and improve the quality of the data.

As discussed above, the data analysis module 630 may be configured inside of the proposed communications device or configured in a cloud server. When the data analysis module 630 is configured inside of the proposed communications device, the data analysis module 630 may directly obtain the context information from the sensor module 620 and obtain the spatial profile from the communications state measurement module 614. When the data analysis module 630 is configured in a cloud server, the data analysis module may obtain the spatial profile and the context information from the communications control module 613, and the communications control module 613 may communicate with the data analysis module 630 to obtain the result of the data analysis result when needed.

The data fusion and processing module 616 may receive the spatial profile from the communications state measurement module 614, receive the data analysis result from the data analysis module 630 and receive the predicted subsequent status from the prediction module 615, and determine the optimum action according to the spatial profile, the predicted subsequent status and the training data points in the data analysis result.

According to an embodiment of the invention, the data fusion and processing module 616 may determine the optimum action by calculating an optimum set of transmitting beams or an optimum set of receiving beams for the transceiver module to search, track and/or adjust the one or more transmitting beams or the one or more receiving beams according to the spatial profile, the predicted subsequent status and the training data points in the data analysis result. For example, based on the predicted subsequent status predicted by the prediction module 615 and the spatial profile, the data fusion and processing module 616 may look up the data analysis result and/or the training data points in the database and find an optimum set of transmitting beams or an optimum set of receiving beams for the predicted subsequent status.

The data fusion and processing module 616 may provide further information regarding the optimum action, such as the optimum set of transmitting beams and/or an optimum set of receiving beams as a bias or initialization for beam searching or beam tracking, to the beam searcher and tracker 617. The beam searcher and tracker 617 may communicate with the transceiver module 611 about the optimum action, such as providing or setting some related parameters, so that the transceiver module 611 may further control the antenna module to perform the beam-search procedure, the beam-track procedure, and/or the beam adjustment procedure based on the optimum action.

After the beam-search procedure, the beam-track procedure, and/or the beam adjustment procedure, an optimum pair of transmitting beam(s) and receiving beam(s) can be formed. Here, the optimum pair of transmitting beam(s) and receiving beam(s) may be the pair of optimum transmitting beam(s) of a first communications device and optimum receiving beam(s) of a second communications device, or the pair of optimum receiving beam(s) of a first communications device and optimum transmitting beam(s) of a second communications device. The first communications device may transmit and receive a plurality of signals to and from the second communications device through the air interface via the optimum transmitting beam(s) and the optimum receiving beam(s).

According to the embodiments of the invention, with the context information, the predicted subsequent status, the spatial profile and/or the data analysis result, the number of transmitting beams in the optimum set and the number of receiving beams in the optimum set determined by the data fusion and processing module 616 can be less than the number of possible transmitting beams and receiving beams supported by the communications device. Therefore, the beam-search procedure, the beam-track procedure, and/or the beam adjustment procedure can be sped up and the overhead of performing these procedures can be reduced.

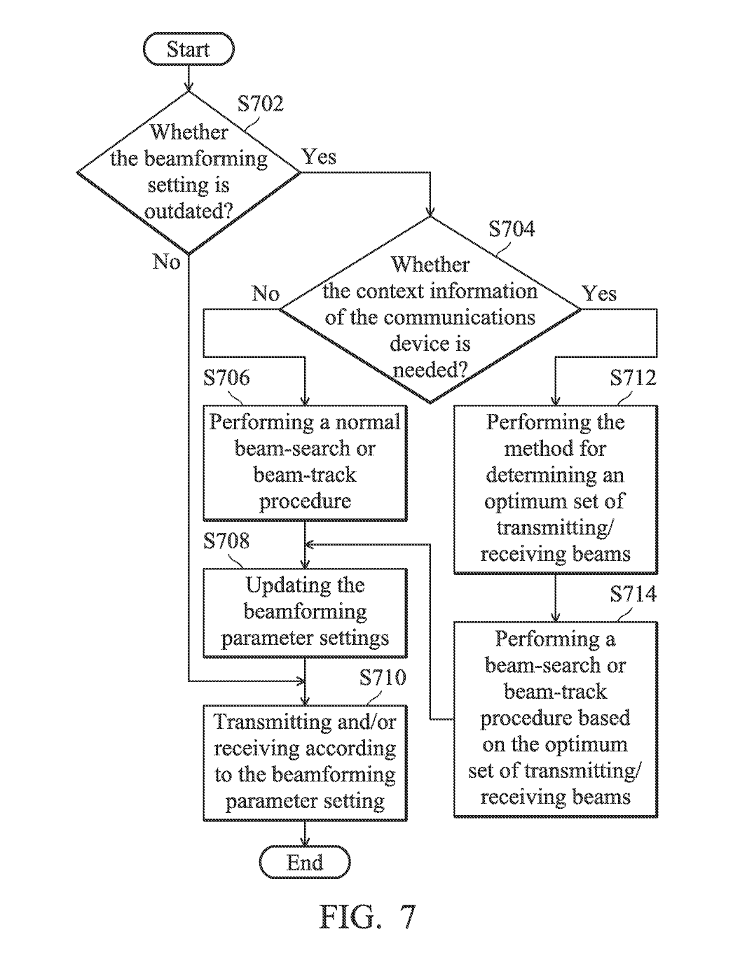

FIG. 7 is a flow chart of a method to speed up the beam-search or beam-track procedure according to an embodiment of the invention. The communications control module may first determine whether the beamforming setting is outdated (Step S702). The communications control module may determine that the beamforming setting is outdated when the received signal strength is greatly reduced. If not, the communications control module may direct the transceiver module to transmit and/or receive according to the beamforming parameter setting (Step S710). When the beamforming setting is outdated, the communications control module may further determine whether the context information of the communications device is needed (Step S704).

According to an embodiment of the invention, the communications control module may determine if the context information of the communications device is needed when the communications device is just power on, or when the communications device operates in a long DTX/DRX cycle, or when the communications device is moving at a high speed, or others. If not, the communications control module may determine to perform a normal beam-search or beam-track procedure (Step S706), and then update the beamforming parameter settings (Step S708) according to the result of the beam-search or beam-track procedure. Following that, the communications control module may direct the transceiver module to transmit and/or receive according to the beamforming parameter setting (Step S710).

On the other hand, when the context information of the communications device is needed, the communications control module may perform the method for determining an optimum set of transmitting/receiving beams as discussed above (Step S712), and then perform a beam-search or beam-track procedure based on the optimum set of transmitting/receiving beams determined in step S712 (Step S714).

Following that, the beamforming parameter settings are updated in step S708 according to the result of the beam-search or beam-track procedure, and the communications control module may direct the transceiver module to transmit and/or receive according to the beamforming parameter setting (Step S710).

As discussed above, unlike the normal beam-search or beam-track procedure, in the embodiments of the invention, with the context information of the communications device, an optimum set of transmitting beams and/or receiving beams can be determined, and the number of transmitting beams and receiving beams in the optimum set can be less than the number of possible transmitting beams and receiving beams supported by the communications device to be searched or tracked. Therefore, the beam-search procedure, the beam-track procedure, and/or the beam adjustment procedure can be sped up and the overhead of performing these procedures can be reduced.

The above-described embodiments of the present invention can be implemented in any of numerous ways. For example, the embodiments may be implemented using hardware, software or a combination thereof. It should be appreciated that any component or collection of components that perform the functions described above can be generically considered as one or more processors that control the above discussed function. The one or more processors can be implemented in numerous ways, such as with dedicated hardware, or with general purpose hardware that is programmed using microcode or software to perform the functions recited above.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A communications device, comprising:
a transceiver module, transmitting and receiving a plurality of signals to and from an air interface via one or more transmitting beams and one or more receiving beams;
a communications state measurement module, measuring strength of the received signals to obtain a spatial profile comprising information regarding received signal strength for the one or more receiving beams with respect to one or more transmitting beams of another communications device communicating with the communications device;
a sensor module, sensing a status of the communications device to obtain context information of the communications device according to the sensed status; and
a communications control module, obtaining the spatial profile from the communications state measurement module and the context information from the sensor module and determining an optimum action to control the transceiver module to search, track and/or adjust the one or more transmitting beams according to the spatial profile and the context information.

2. The communications device as claimed in claim 1, wherein the status of the communications device comprises at least one of a location, a 3D orientation, a proximity to a path-blocking object and a moving speed of the communications device.

3. The communications device as claimed in claim 1, wherein the sensor module comprises at least one of a Global Positioning System (GPS) receiver, a gyroscope sensor, a proximity sensor and a gravity sensor.

4. The communications device as claimed in claim 1, wherein the communications control module determines the optimum action further according to a data analysis result obtained from a data analysis module.

5. The communications device as claimed in claim 4, wherein the data analysis module obtains the spatial profile and the context information, synchronizes the spatial profile with the context information obtained at a predetermined time to form a training data point, and analyzes a plurality of training data points obtained at different time to generate the data analysis result.

6. The communications device as claimed in claim 5, wherein the data analysis module further processes data associated with the training data points by filtering, averaging, interpolating and/or extrapolating the data.

7. The communications device as claimed in claim 5, further comprising the data analysis module, wherein the data analysis module obtains the spatial profile from the communications state measurement module and obtains the context information from the sensor module.

8. The communications device as claimed in claim 5, wherein the communications control module communicates with the data analysis module configured in a cloud server to obtain the data analysis result, and wherein the data analysis module obtains the spatial profile and the context information from the communications control module.

9. The communications device as claimed in claim 5, wherein the communications control module comprises:
a prediction module, receiving the context information from the sensor module and predicting a subsequent status of the communications device according to the received context information; and
a data fusion and processing module, receiving the spatial profile from the communications state measurement module, receiving the data analysis result from the data analysis module and receiving the predicted subsequent status from the prediction module, and determining the optimum action according to the spatial profile, the predicted subsequent status and the training data points in the data analysis result.

10. The communications device as claimed in claim 9, wherein the data fusion and processing module determines the optimum action by calculating an optimum set of transmitting beams for the transceiver module to search, track and/or adjust the one or more transmitting beams according to the spatial profile, the predicted subsequent status and the training data points in the data analysis result.

11. A communications device, comprising:
a transceiver module, transmitting and receiving a plurality of signals to and from an air interface via one or more transmitting beams and one or more receiving beams;
a communications state measurement module, measuring strength of the received signals to obtain a spatial profile comprising information regarding received signal strength for the one or more receiving beams with respect to one or more transmitting beams of another communications device communicating with the communications device;
a sensor module, sensing a status of the communications device to obtain context information of the communications device according to the sensed status; and
a communications control module, obtaining the spatial profile from the communications state measurement module and the context information from the sensor module and determining an optimum action to control the transceiver module to search, track and/or adjust the one or more receiving beams according to the spatial profile and the context information.

12. The communications device as claimed in claim 11, wherein the status of the communications device comprises at least one of a location, a 3D orientation, a proximity to a path-blocking object and a moving speed of the communications device.

13. The communications device as claimed in claim 11, wherein the sensor module comprises at least one of a Global Positioning System (GPS) receiver, a gyroscope sensor, a proximity sensor and a gravity sensor.

14. The communications device as claimed in claim 11, wherein the communications control module determines the optimum action further according to a data analysis result obtained from a data analysis module.

15. The communications device as claimed in claim 14, wherein the data analysis module obtains the spatial profile and the context information, synchronizes the spatial profile with the context information obtained at a predetermined time to form a training data point, and analyzes a plurality of training data points obtained at different time to generate the data analysis result.

16. The communications device as claimed in claim 15, wherein the data analysis module further processes data associated with the training data points by filtering, averaging, interpolating and/or extrapolating the data.

17. The communications device as claimed in claim 15, further comprising the data analysis module, wherein the data analysis module obtains the spatial profile from the communications state measurement module and obtains the context information from the sensor module.

18. The communications device as claimed in claim 15, wherein the communications control module communicates with the data analysis module configured in a cloud server to obtain the data analysis result, and wherein the data analysis module obtains the spatial profile and the context information from the communications control module.

19. The communications device as claimed in claim 15, wherein the communications control module comprises:
a prediction module, receiving the context information from the sensor module and predicting a subsequent status of the communications device according to the received context information; and
a data fusion and processing module, receiving the spatial profile from the communications state measurement module, receiving the data analysis result from the data analysis module and receiving the predicted subsequent status from the prediction module, and determining the optimum action according to the spatial profile, the predicted subsequent status and the training data points in the data analysis result.

20. The communications device as claimed in claim 9, wherein the data fusion and processing module determines the optimum action by calculating an optimum set of transmitting beams and/or an optimum set of receiving beams for the transceiver module to search, track and/or adjust the one or more receiving beams according to the spatial profile, the predicted subsequent status and the training data points in the data analysis result.

21. A method for determining an optimum set of transmitting/receiving beams for a first communications device, comprising:
measuring strength of a plurality of signals received via one or more receiving beams of the first communications device to obtain a spatial profile comprising information regarding the received signal strength for the one or more receiving beams of the first communications device with respect to one or more transmitting beams of a second communications device communicating with the first communications device;
sensing a status of the communications device to obtain context information of the communications device according to the sensed status; and
determining an optimum action to control a transceiver module of the communications device to search, track and/or adjust the one or more receiving beams or one or more transmitting beams according to the spatial profile and the context information.

22. The method as claimed in claim 21, wherein the status of the communications device comprises at least one of a location, a 3D orientation, a proximity to a path-blocking object and a moving speed of the communications device.

23. The method as claimed in claim 21, wherein the optimum action is determined further according to a data analysis result, and wherein the determining step further comprises:
communicating with a data analysis module configured in a cloud server to obtain the data analysis result.

24. The method as claimed in claim 21, wherein the optimum action is determined further according to a data analysis result, and wherein the determining step further comprises:
synchronizing the spatial profile with the context information obtained at a predetermined time to form a training data point;
analyzing a plurality of training data points obtained at different time to generate the data analysis result; and
determining the optimum action according to the spatial profile, the context information and the data analysis result.

25. The method as claimed in claim 24, further comprising:
processing data associated with the training data points by filtering, averaging, interpolating and/or extrapolating the data to generate the data analysis result.

26. The method as claimed in claim 24, further comprising:
predicting a subsequent status of communications device according to the context information; and
determining the optimum action according to the spatial profile, the predicted subsequent status and the training data points in the data analysis result.

27. The method as claimed in claim 26, wherein the determining step further comprises:
calculating an optimum set of transmitting beams or an optimum set of receiving beams for the transceiver module to search, track and/or adjust the one or more transmitting or the one or more receiving beams according to the spatial profile, the predicted subsequent status and the training data points in the data analysis result.
